(19) United States
(12) Patent Application Publication
(10) Pub. No.: US 2024/0375460 A1
(43) Pub. Date: Nov. 14, 2024

(54) TIRE AIR FILLING DEVICE

(71) Applicant: MURAKAMI CORPORATION, Shizuoka (JP)

(72) Inventors: Hidenori SATO, Shizuoka (JP); Naomi SUGIMURA, Shizuoka (JP)

(73) Assignee: MURAKAMI CORPORATION, Shizuoka (JP)

(21) Appl. No.: 18/690,874

(22) PCT Filed: Sep. 8, 2022
(86) PCT No.: PCT/JP2022/033770

§ 371 Date: Mar. 11, 2024

(30) Foreign Application Priority Data
Sep. 13, 2021 (JP) 2021-148835

(51) Int. Cl. B60C 23/12

(52) U.S. Cl. CPC B60C 23/133; B60C 23/126

(57) ABSTRACT

A tire air filling device according to one embodiment includes a cylinder having a first opening communicating with a tire; and a weight that has an air flow hole through which air to be supplied to the tire passes, and that moves in an axial direction of the cylinder upon a receipt of a centrifugal force, to supply the air from the first opening to the tire. The tire air filling device includes a weight airtight member interposed between the weight and an inner surface of the cylinder; and a weight spring that biases the weight to a side opposite to the tire. The cylinder has a second opening on a side opposite to the first opening, and a cap that is detachably attached to the second opening is provided.

### TECHNICAL FIELD

The present disclosure relates to a tire air filling device that fills an inside of a tire with air.

Priority is claimed on Japanese Patent Application No. 2021-148835, filed on Sep. 13, 2021, the entire content of which is incorporated herein by reference.

### BACKGROUND ART

In the related art, a tire air filling device that fills the inside of a tire of an automobile or the like with air has been known. Japanese Unexamined Patent Publication No. 2008-308081 discloses an air pressure adjustment device attached to a spoke of a wheel. A part of the air pressure adjustment device protrudes from an outer peripheral surface of a rim of the wheel into an internal space of a tire. The air pressure adjustment device includes a cylinder screwed into the spoke, and a piston that is reciprocatably provided inside the cylinder.

A first umbrella valve that opens and closes an air flow path in the cylinder is attached to an end portion on a tire side of the cylinder. The first umbrella valve functions as a check valve that prevents a backflow of the air from the internal space of the tire to the inside of the cylinder. When an air pressure inside the cylinder is larger than an air pressure in the internal space of the tire, the first umbrella valve opens a flow path, and allows the air to flow from the inside of the cylinder to the internal space of the tire. When the air pressure inside the cylinder is smaller than the air pressure in the internal space of the tire, the first umbrella valve prevents the air from flowing.

The piston partitions an internal space of the cylinder into a first chamber and a second chamber, and the second chamber communicates with the internal space of the tire. A recess is formed at an end portion of the piston exposed to the first chamber, and a partition wall is provided in the recess. The partition wall defines a third chamber, which is partitioned off from the first chamber, inside the piston. A second umbrella valve that opens and closes a through-hole of the piston, which is an air flow path from the first chamber to the third chamber, is attached to the partition wall. A coil spring that biases the piston toward the first chamber is disposed between the piston and a bottom surface of the internal space of the cylinder.

In the air pressure adjustment device, when the rotation speed of the wheel increases as an automobile travels, a centrifugal force acts on the piston. As the centrifugal force acts, the piston moves against the biasing force of the coil spring to reduce the volume of the second chamber. When the second chamber is reduced in volume, the air pressure of the second chamber is increased. When the air pressure in the internal space of the tire is lower than a reference air pressure, the first umbrella valve is opened, and the air in the second chamber is injected into the internal space of the tire.

When the automobile decelerates and the rotation speed of the wheel slows down, the biasing force of the coil spring moves the piston in a direction in which the volume of the second chamber is increased. When the pressure in the second chamber decreases and becomes lower than the air pressure in the internal space of the tire, the first umbrella valve is closed. In the movement process of the piston, when the pressure in the second chamber becomes lower than a pressure in the first chamber, the second umbrella valve is opened, and the air is introduced from the first chamber into the second chamber.

### CITATION LIST

### Patent Literature

Patent Literature 1: Japanese Unexamined Patent Publication No. 2008-308081

### SUMMARY OF INVENTION

### Technical Problem

In the air pressure adjustment device described above, when the volume of the second chamber inside the cylinder is reduced as the piston moves due to a centrifugal force, the air pressure in the second chamber is increased. When the air pressure in the internal space of the tire is lower than the reference air pressure, the first umbrella valve is opened, so that the air in the second chamber is injected into the internal space of the tire. Therefore, the tire can be filled with the air by a centrifugal force generated during traveling. However, it may be necessary to fill the tire with the air during traveling and to supply the air to the tire even during stop of traveling. In this case, efficiently performing the supply of the air to the tire even during stop of traveling is required.

An object of the present disclosure is to provide a tire air filling device capable of filling a tire with air during traveling and capable of efficiently supplying the air to the tire during stop of traveling.

### Solution to Problem

(1) A tire air filling device according to the present disclosure is provided on a wheel attached to a tire, and compresses air and fills an inside of the tire with the air. The tire air filling device includes a cylinder having a first opening communicating with the tire; and a weight that is provided inside the cylinder, that has an air flow hole through which the air to be supplied to the tire passes, and that moves in an axial direction of the cylinder upon a receipt of a centrifugal force, to supply the air from the first opening to the tire. The tire air filling device includes a weight airtight member interposed between the weight and an inner surface of the cylinder; and a weight spring that biases the weight to a side opposite to the tire. The cylinder has a second opening on a side opposite to the first opening, and a cap that is detachably attached to the second opening is provided.

In the tire air filling device, the cylinder has the first opening communicating with the inside of the tire, and the weight that supplies the air to the inside of the tire via the first opening is provided inside the cylinder. The weight is moved in the axial direction of the cylinder by the centrifugal force, thereby being able to fill the tire with the air during traveling. The tire air filling device has the second opening facing the side opposite to the first opening, and the cap is detachably attached to the second opening. During stop of traveling, by opening the second opening through opening the cap, the air can be forcibly supplied from the second opening to the tire. During traveling, the cap is closed, so that the weight can fill the tire with the air using a centrifugal force, and during stop of traveling, the cap is removed, so that the air can be directly supplied from the second opening to the tire.
(2) In (1) described above, the tire air filling device may further include a plurality of the weight airtight members. The plurality of weight airtight members may be aligned along the axial direction. A cross section of each of the plurality of weight airtight members taken along a plane extending along the axial direction may have a U-shape with an open end. The plurality of weight airtight members may be disposed such that the open ends face a first opening side. By the way, when an O-ring is used as the airtight member, high dimensional accuracy is required depending on the inner diameter of the cylinder, the outer diameter of the weight, or the like. On the other hand, when the weight airtight member having a U-shaped cross section when taken along a plane extending along the axial direction is used, the dimensional accuracy can be relaxed. The U-shaped open ends of the plurality of weight airtight members face the first opening side. Therefore, sliding resistance when the weight returns due to the biasing force of the weight spring is reduced, so that the air pushed into the tire can be made to be less likely to leak.
(3) In (1) or (2) described above, the tire air filling device described above may further include a backflow prevention valve provided inside the weight, and preventing a backflow of the air from the weight to the side opposite to the tire. The backflow prevention valve may include a slide member that slides in the axial direction in the air flow hole. A specific gravity of the slide member may be smaller than a specific gravity of the weight. In this case, when the centrifugal force increases to move the weight to the first opening side (tire side), and the air pressure on the first opening side of the cylinder increases, the movement of the slide member can be suppressed to prevent the backflow prevention valve from opening unintentionally. Therefore, the air can be more efficiently sent to the tire side due to the weight.
(4) In any of (1) to (3) described above, the tire air filling device described above may further include an inclined member attached to a check valve that prevents a backflow of the air from the tire to the inside of the cylinder, and to the cylinder in a state where the cylinder is inclined with respect to the check valve. In this case, by interposing the inclined member between the check valve and the cylinder, the direction of the cylinder with respect to the check valve can be changed. The inclined member having an inclination angle matching the shape of the wheel can be attached between the cylinder and the check valve. By preparing a plurality of types of the inclined members having different inclination angles and selecting an inclined member matching the shape of a wheel, the tire air filling device can be appropriately attached to various wheels. Therefore, the versatility of the tire air filling device can be increased.
(5) In (4) described above, at least one of the inclined member and the cylinder may include a fragile portion that is more fragile than the check valve and that breaks due to an external force. For example, when the wheel collides with a curb or the like during traveling and the check valve attached to the wheel is damaged, there is a possibility that the air in the tire leaks and an automobile is unable to travel. On the other hand, in a case where the inclined member interposed between the check valve and the cylinder or the cylinder includes a fragile portion as described above, even when the wheel receives an impact force, the fragile portion breaks. Since damage to the check valve can be suppressed by the breakage of the fragile portion provided in at least one of the inclined member and the cylinder, the leakage of the air from the tire due to an impact force on the wheel can be more reliably suppressed.
(6) In (4) described above, the tire air filling device described above may further include a backflow prevention valve provided inside the weight, and preventing a backflow of the air from the weight to the side opposite to the tire. The backflow prevention valve may include a slide member that slides in the axial direction in the air flow hole, and a backflow prevention valve spring that biases the slide member to the side opposite to the tire. The check valve may include a valve seat portion having an air hole, a valve body portion that slides in the air hole, and a check valve spring that biases the valve body portion to the side opposite to the tire. A spring constant of the check valve spring may be larger than a spring constant of the backflow prevention valve spring. In this case, since the spring constant of the check valve spring is larger than the spring constant of the backflow prevention valve spring, the leakage of the air from the tire at the check valve can be more reliably suppressed.
(7) In (4) described above, the tire air filling device described above may further include a backflow prevention valve provided inside the weight, and preventing a backflow of the air from the weight to the side opposite to the tire. The backflow prevention valve may include a slide member that slides in the axial direction in the air flow hole, and a backflow prevention valve spring that biases the slide member to the side opposite to the tire. The check valve may include a valve seat portion having an air hole, a valve body portion that slides in the air hole, and a check valve spring that biases the valve body portion to the side opposite to the tire. A set load of the check valve spring may be larger than a set load of the backflow prevention valve spring. In this case, since the set load of the check valve spring is larger than the set load of the backflow prevention valve spring, the leakage of the air from the tire at the check valve can be more reliably suppressed.
(8) In any of (1) to (7) described above, the tire air filling device described above may further include a backflow prevention valve provided inside the weight, and preventing a backflow of the air from the weight to the side opposite to the tire. The weight may include an accommodation portion that accommodates the backflow prevention valve, and at least a part of the accommodation portion may be inserted into the weight spring. In this case, at least a part of the accommodation portion of the backflow prevention valve is inserted into the weight spring. By inserting the accommodation portion of the weight into the weight spring, a change in the internal space of the cylinder due to the movement of the weight can be increased. Since the pressure generated inside the cylinder can be increased without increasing the size of the cylinder, the supply of the air to the tire can be efficiently performed, and a contribution to making components more compact is made.

### Advantageous Effects of Invention

According to the present disclosure, it is possible to fill the tire with the air during traveling, and to efficiently supply the air to the tire during stop of traveling.

### BRIEF DESCRIPTION OF DRAWINGS

FIG. 1 is a side view schematically showing a tire air filling device, a tire, and a wheel according to an embodiment.

FIG. 2 is a cross-sectional view of the tire air filling device of FIG. 1 taken along line A-A.

FIG. 3 is an exploded perspective view showing the tire air filling device according to the embodiment.

FIG. 4 is a cross-sectional view showing the tire air filling device according to the embodiment.

FIG. 5 is a cross-sectional view showing a state where a cap is removed from the tire air filling device according to the embodiment and a second opening is opened.

FIG. 6 is a cross-sectional view showing a tire air filling device to which an inclined member different from an inclined member of the tire air filling device of FIG. 4 is attached.

FIG. 7 is a cross-sectional view showing a state where the tire air filling device according to the embodiment is broken.

FIG. 8 is a perspective view showing a tire air filling device according to a further modification example.

FIG. 9 is a view of the tire air filling device of FIG. 8 when viewed in a direction different from that in FIG. 8.

FIG. 10 is a cross-sectional view showing the tire air filling device of FIG. 8.

### DESCRIPTION OF EMBODIMENTS

Hereinafter, an embodiment of a tire air filling device according to the present disclosure will be described with reference to the drawings. In the description of the drawings, the same or corresponding elements are denoted by the same reference signs, and duplicate descriptions will be omitted as appropriate. The drawings may be partially simplified or exaggerated for ease of understanding, and dimensional ratios and the like are not limited to those shown in the drawings.

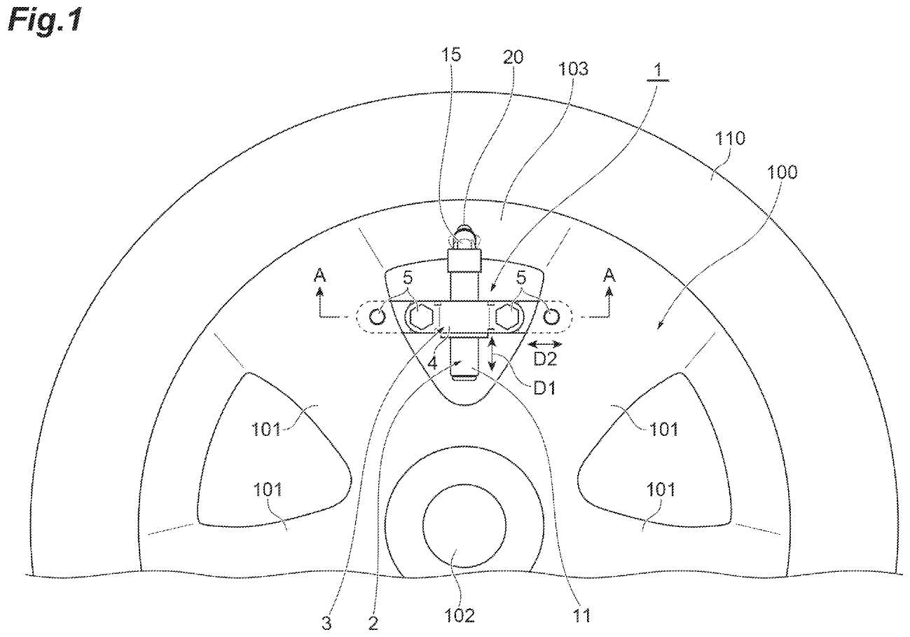

FIG. 1 shows an exemplary wheel 100 and an exemplary tire 110 in which a tire air filling device 1 according to the present embodiment is incorporated. For example, a plurality of the wheels 100 and a plurality of tires 110 are provided on an automobile. Each wheel 100 and each tire 110 rotates as the automobile travels.

The wheel 100 includes a plurality of spokes 101. The plurality

of spokes 101 extend radially from a central portion 102 of the wheel 100. A rim 103 of the wheel 100 is provided on a radially outer side of the plurality of spokes 101. The tire 110 is attached to the rim 103.

The tire air filling device 1 is attached to, for example, two spokes 101 to span two spokes 101. The tire air filling device 1 is provided, for example, between the central portion 102 and the rim 103 of the wheel 100. The tire air filling device 1 receives a centrifugal force in a radial direction of the tire 110 as the automobile travels and as the wheel 100 and the tire 110 rotate.

The tire air filling device 1 generates compressed air from the centrifugal force received due to the rotation of the tire 110, and fills the inside of the tire 110 with the compressed air. The wheel 100 may include one tire air filling device 1 or may include a plurality of the tire air filling devices 1. Each of the plurality of tires 110 may be provided with the tire air filling device 1. FIG. 1 shows an example in which one tire air filling device 1 is attached to one tire 110.

The tire air filling device 1 includes a device body 2 that generates compressed air to be supplied to the tire 110, and an attachment member 3 that attaches the device body 2 to the wheel 100. The device body 2 includes a cylinder 11, a check valve 20, and an inclined member 15. The cylinder 11 generates compressed air thereinside, and the check valve 20 prevents a backflow of air from the tire 110 to the cylinder 11. The inclined member 15 connects the cylinder 11 and the check valve 20 to each other.

For example, the check valve 20 is attached to the wheel 100 (as one example, the rim 103). An internal space of the check valve 20 communicates with an internal space of the tire 110. Therefore, the compressed air generated inside the cylinder 11 is supplied to the internal space of the tire 110 through the inclined member 15 and the check valve 20. In the present embodiment, the device body 2 includes the inclined member 15 that is attached to the check valve 20 and the cylinder 11 in a state where the check valve 20 is inclined with respect to the cylinder 11.

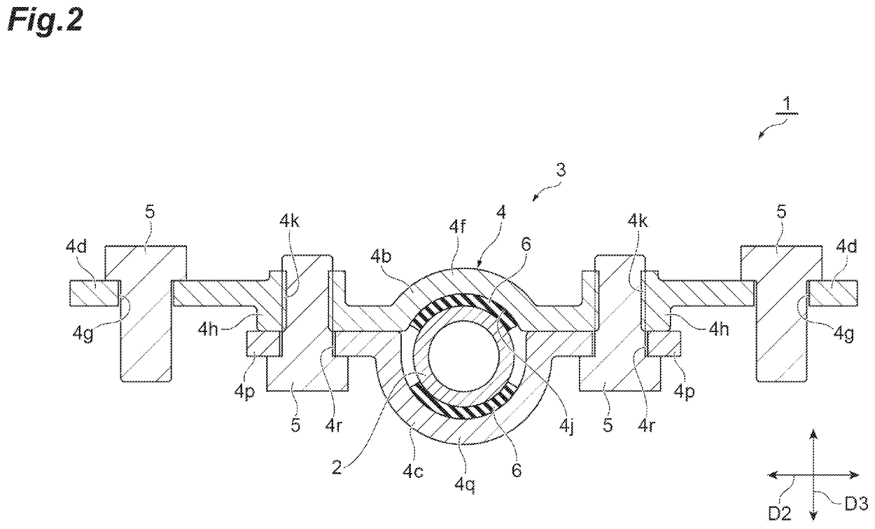

FIG. 2 is a cross-sectional view of the tire air filling device 1 of FIG. 1 taken along line A-A. As shown in FIGS. 1 and 2, the attachment member 3 as one example includes a clamp 4 and a plurality of bolts 5. The clamp 4 includes, for example, a first clamp portion 4b and a second clamp portion 4c that sandwich the device body 2 therebetween. For example, the device body 2 is attached to the wheel 100 to extend along a first direction D1 that is the radial direction of the tire 110. The clamp 4 extends along a second direction D2 intersecting the first direction D1. The second direction D2 corresponds to a direction in which a pair of the spokes 101 are aligned.

As one example, a length of the first clamp portion 4b in the second direction D2 is longer than a length of the second clamp portion 4c in the second direction D2. For example, the first clamp portion 4b is attached to the spokes 101 and the second clamp portion 4c. The first clamp portion 4b includes a pair of end portions 4d aligned along the second direction D2, and a central portion 4f located between the pair of end portions 4d.

For example, the first clamp portion 4b and the second clamp portion 4c overlap each other along a third direction D3 intersecting both the first direction D1 and the second direction D2. The third direction

D3 corresponds to a thickness direction of the first clamp portion 4b and the second clamp portion 4c. In a state where the second clamp portion 4c overlaps the first clamp portion 4b, the pair of end portions 4d protrude further in the second direction D2 than the second clamp portion 4c. An insertion hole 4g into which the bolt 5 to be screwed into the spoke 101 is inserted is formed in each of the pair of end portions 4d.

The central portion 4f is a portion that the second clamp portion 4c overlaps. The central portion 4f includes a protruding portion 4h protruding from the end portions 4d, and a recess 4j recessed at the center of the protruding portion 4h in the second direction D2. Screw holes 4k into which the bolts 5 inserted into the second clamp portion 4c are screwed are formed in the protruding portion 4h. The recess 4j is a portion into which the device body 2 is inserted, and has, for example, a shape along an outer periphery of the device body 2. As one example, the recess 4j has an arc shape.

The second clamp portion 4c includes a pair of end portions 4p aligned along the second direction D2, and a central portion 4q located between the pair of end portions 4p. An insertion hole 4r into which the bolt 5 to be screwed into the screw hole 4k of the first clamp portion 4b is inserted is formed in each of the pair of end portions 4p. The central portion 4q is a portion facing the central portion 4f of the first clamp portion 4b along the third direction D3.

The central portion 4q is curved away from the recess 4j as the central portion 4q extends toward the center in the second direction D2. The central portion 4q forms a space through which the device body 2 passes, together with the recess 4j. For example, cushioning materials 6 are disposed in this space between the clamp 4 and the device body 2. As one example, a plurality of the cushioning materials 6 are interposed between the clamp 4 and the device body 2. Examples of the configurations of the attachment member 3 and the clamp 4 have been described above. However, the configurations of the attachment member 3 and the clamp 4 are not limited to the above examples, and can be changed as appropriate.

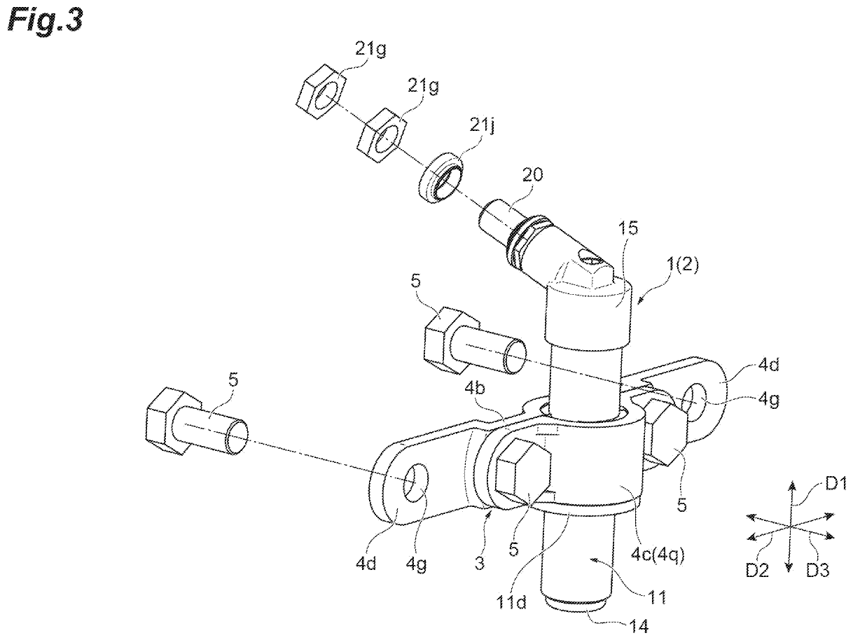

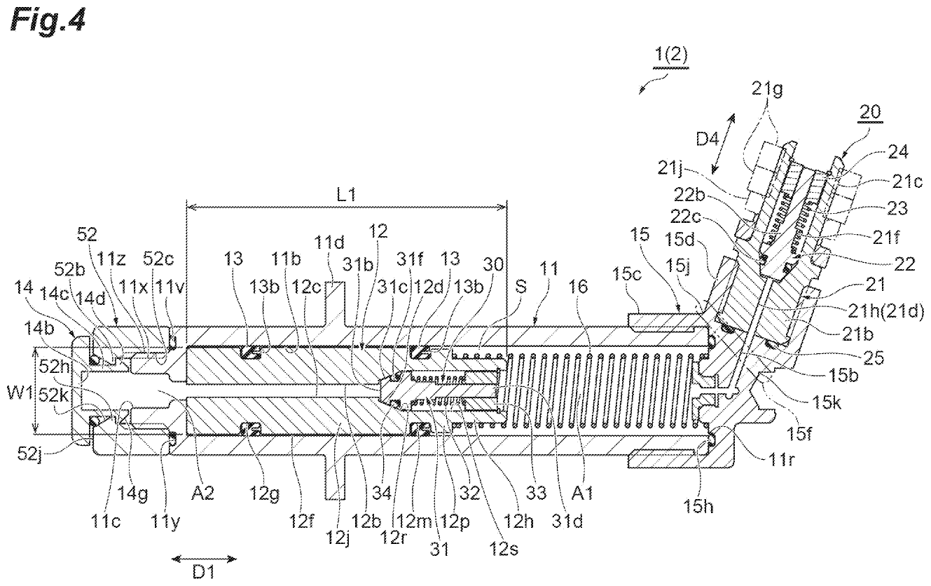

Next, a configuration of the tire air filling device 1 (device body 2) will be described with reference to FIGS. 3 and 4. As shown in FIGS. 3 and 4, the tire air filling device 1 includes the cylinder 11, a weight 12, and a weight airtight member 13. The cylinder 11 has a tubular shape. The weight 12 moves inside the cylinder 11 in the first direction D1 corresponding to an axial direction of the cylinder 11. The weight airtight member 13 is interposed between an inner surface 11b of the cylinder 11 and the weight 12. The cylinder 11 has a first opening 11r located on a tire 110 side (check valve 20 side) and a second opening 11c located on a side opposite to the tire 110. As one example, grease may be applied between the weight airtight member 13 and the inner surface 11b.

The cylinder 11 includes, for example, a flange portion 11d on which the attachment member 3 is placed. The attachment member 3 is attached to the pair of spokes 101 in a state where the attachment member 3 is placed on the flange portion 11d. Accordingly, the tire air filling device 1 can be attached to the pair of spokes 101 in a stable state. As one example, the weight 12 has a columnar shape. A width W1 of the weight 12 is, for example, 5 mm or more and 15 mm or less.

Since the width W1 is 15 mm or less, the air pressure due to the movement of the weight 12 in the first direction D1 can be effectively increased. For example, the width W1 (length in the second direction D2) of the weight 12 is smaller than a width of the spoke 101. As shown in FIGS. 3 and 4, as one example, the weight 12 has a columnar shape. In this case, the width W1 corresponds to a diameter of the weight 12.

A length L1 of the weight 12 in the first direction D1 is, as one example, 20 mm or more and 45 mm or less. Since the length L1 is 45 mm or less, a large movement amount of the weight 12 inside the cylinder 11 can be ensured. However, the values of the width W1 and of the length L1 are not limited to the above examples.

The weight 12 and the weight airtight member 13 divide an internal region of the cylinder 11 into a first region A1 on the tire 110 side and a second region A2 on the side opposite to the tire 110. The weight 12 and the weight airtight member 13 reciprocate inside the cylinder 11 along the first direction D1 corresponding to the radial direction of the wheel 100.

The cylinder 11 has, for example, a cylindrical shape. The cylinder 11 has the second opening 11c that allows air to flow into the second region A2 of the cylinder 11. A lid member 14 is attached to the second opening 11c with a cap 52 interposed therebetween. The second opening 11c and the lid member 14 are provided on the side opposite to the tire 110 when viewed from the weight 12 (the lower side in FIG. 3 and the left side in FIG. 4). The lid member 14 is, for example, a filter that allows gases such as air to pass, but does not allow liquids and solids to pass.

As one example, the lid member 14 includes a sealing portion 14b that seals the second opening 11c; a protruding portion 14c protruding from the sealing portion 14b in the first direction D1; and an engagement portion 14d located at an end portion of the protruding portion 14c. The sealing portion 14b allows gas to pass from the outside of the cylinder 11 to the inside of the cylinder 11. The sealing portion 14b blocks the entry of liquids and solids to the inside of the cylinder 11. The sealing portion 14b has, for example, a disk shape.

The protruding portion 14c is, for example, an annular portion protruding from a radially inner side of the sealing portion 14b in the first direction D1. The engagement portion 14d includes a protrusion, which protrudes to a radially outer side of the protruding portion 14c, at the end portion of the protruding portion 14c. The protrusion has a tapered surface 14g that is inclined to be reduced in diameter as the tapered surface 14g extends away from the sealing portion 14b.

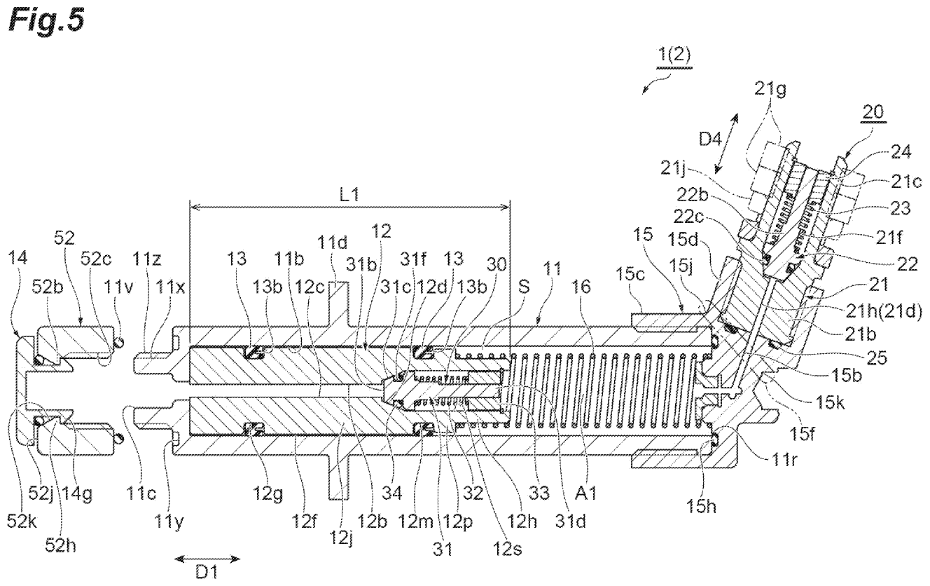

As shown in FIGS. 4 and 5, the tire air filling device 1 includes the cap 52 that is detachably attached to the second opening 11c of the cylinder 11. FIG. 5 shows a state where the cap 52 is removed from the cylinder 11. In the tire air filling device 1, the lid member 14 is attached to the cylinder 11 with the cap 52 interposed therebetween. The cylinder 11 includes a tubular portion 11x protruding toward the lid member 14, and a recess 11y located on a radially outer side of the tubular portion 11x and recessed in the first direction D1. A male screw 11z is formed on an outer peripheral surface of the tubular portion 11x. An O-ring 11v is fitted into the recess 11y.

The cap 52 has a tubular shape. The cap 52 includes an engagement portion 52b into which the lid member 14 is fitted, and a screw portion 52c screwed into the cylinder 11. The engagement portion 52b includes a protrusion 52h protruding to a radially inner side of the cap 52. The protrusion 52h has a tapered surface 52k that is inclined in a protruding direction of the protrusion 52h as the tapered surface 52k extends away from an end surface 52j of the cap 52. The lid member 14 is engaged with the cap 52 by causing the tapered surface 14g to climb over the tapered surface 52k.

The screw portion 52c is a female screw to which the male screw 11z of the tubular portion 11x of the cylinder 11 is screwed. The cap 52 is attached to the cylinder 11 by screwing the male screw 11z into the screw portion 52c. The cap 52 is detachably attached to the cylinder 11. By removing the cap 52, air can be forcibly supplied from the second opening 11c into the tire 110 via the insides of the cylinder 11, the inclined member 15, and the check valve 20.

Air flows into the weight 12 via the lid member 14 and the second opening 11c of the cylinder 11. The weight 12 has, for example, a columnar shape. An annular recess 12g is formed on an outer peripheral surface 12f of the weight 12. The weight airtight member 13 is inserted into the annular recess 12g.

The tire air filling device 1 includes a plurality of the weight airtight members 13. The plurality of weight airtight members 13 are aligned along the first direction D1. A cross section of each of the plurality of weight airtight members 13 taken along a plane aligned along the first direction D1 has a U-shape with an open end 13b. In the present disclosure, the “U-shape” includes not only a strict U-shape but also a shape slightly different from the U-shape, such as a V-shape or a C-shape. As one example, the weight airtight members 13 are lip seals. The plurality of weight airtight members 13 are disposed such that the open ends 13b face a first opening 11r side of the cylinder 11. Sliding resistance when the weight 12 returns due to the biasing force of a weight spring 16 is smaller than sliding resistance when the weight 12 moves to the tire 110 side.

An air flow hole 12b through which air that has flowed in flows to a side opposite to the second opening 11c is formed in the weight 12. For example, the air flow hole 12b includes a first space portion 12c located on a second opening 11c side, and a second space portion 12d extending from the first space portion 12c toward the tire 110 side. As one example, the second space portion 12d has a more increased diameter than the first space portion 12c. The second space portion 12d is defined by a tapered surface 12r that is gradually increased in diameter as the tapered surface 12r extends away from the first space portion 12c, and an inner peripheral surface 12s interposed between the tapered surface 12r and the first region A1.

The weight 12 is made of, for example, a material containing tungsten. The weight 12 may be made of tungsten or a tungsten alloy. The weight 12 is, for example, a high specific gravity material having a larger specific gravity than the cylinder 11. As one example, a specific gravity of the weight 12 is 15 or more. In this case, it is possible to increase the mass of the weight 12 while realizing a reduction in the diameter of the weight 12. Therefore, the reciprocation of the weight 12 in the first direction D1 due to a centrifugal force can be sufficiently performed, and the supply of air to the tire 110 can be more sufficiently performed.

The tire air filling device 1 includes the weight spring 16 disposed to extend from the weight 12 toward the tire 110 side. The weight spring 16 is a spring that biases the weight 12 to the side opposite to the tire 110.

The weight 12 includes an accommodation portion 12h that accommodates a backflow prevention valve 30 to be described later, and a large-diameter portion 12j having a larger diameter than the accommodation portion 12h.

At least a part of the accommodation portion 12h is inserted into the weight spring 16. The accommodation portion 12h and the large-diameter portion 12j have, for example, a tubular shape. An outer diameter of the accommodation portion 12h is smaller than an inner diameter of the cylinder 11. A gap S is formed between an outer surface of the accommodation portion 12h and the inner surface 11b of the cylinder 11. The annular recess 12g is formed on the outer surface of the large-diameter portion 12j. The weight airtight member 13 is inserted into the annular recess 12g.

The accommodation portion 12h includes an annular protrusion 12p, which protrudes to a radially outer side of the weight 12, at a location away from the large-diameter portion 12j. An annular recess 12m is formed between the annular protrusion 12p and the large-diameter portion 12j. The weight airtight member 13 is inserted into the annular recess 12m. The weight spring 16 is disposed between the annular protrusion 12p and the inclined member 15.

The tire air filling device 1 includes the backflow prevention valve 30 that prevents a backflow of air from the weight 12 to the side opposite to the tire 110. The backflow prevention valve 30 includes a slide member 31, a backflow prevention valve spring 32, a support portion 33, and a backflow prevention valve airtight member 34. The slide member 31 slides, for example, in the first direction D1 in the air flow hole 12b. The backflow prevention valve spring 32 biases the slide member 31 to the side opposite to the tire 110. The support portion 33 supports an end portion of the backflow prevention valve spring 32 in the first direction D1. The backflow prevention valve airtight member 34 is interposed between an inner surface of the air flow hole 12b and the slide member 31.

A specific gravity of the slide member 31 is, for example, smaller than the specific gravity of the weight 12. The slide member 31 is made of, for example, aluminum. The slide member 31 slides, for example, along the first direction D1 in the air flow hole 12b (second space portion 12d) of the weight 12. The slide member 31 includes an end surface 31b facing the first space portion 12c; an inclined surface 31c extending from the end surface 3 1b along the tapered surface 12r; and a shaft portion 31d extending from the inclined surface 31c toward the support portion 33, and partially inserted into the support portion 33.

An annular recess 31f is formed on the inclined surface 31c of the slide member 31. The backflow prevention valve airtight member 34 is inserted into the annular recess 31f. The backflow prevention valve airtight member 34 is, for example, an O-ring. The backflow prevention valve airtight member 34 is made of, for example, EPDM. Grease may be applied between the backflow prevention valve airtight member 34 and the inner surface of the air flow hole 12b.

The backflow prevention valve spring 32 is made of, for example, Steel Use Stainless (SUS). The backflow prevention valve spring 32 is provided in the second space portion 12d. The backflow prevention valve spring 32 is disposed outside the shaft portion 31d of the slide member 31 in the radial direction, and extends in the first direction D1 between the slide member 31 and the support portion 33. The support portion 33 is made of, for example, aluminum. The support portion 33 is a bearing for the shaft portion 31d of the slide member 31.

The slide member 31 and the backflow prevention valve airtight member 34 are movable in the first direction D1 with respect to the support portion 33. When the slide member 31 and the backflow prevention valve airtight member 34 have moved to the side opposite to the tire 110 with respect to the weight 12, the backflow prevention valve airtight member 34 comes into contact with the tapered surface 12r, to close the air flow hole 12b. On the other hand, when the slide member 31 and the backflow prevention valve airtight member 34 have moved to the tire 110 side with respect to the weight 12, the air flow hole 12b is opened.

Next, the check valve 20 will be described. The check valve 20 is attached to, for example, an air hole formed in the wheel 100, and air is supplied from the check valve 20 to the internal space of the tire 110 via the air hole. For example, the shapes of some components of the check valve 20 are the same as the shapes of the components included in the weight 12. Accordingly, the components can be shared, thereby contributing to reducing the cost of components.

The check valve 20 includes a valve seat portion 21 having an air hole 21h through which air from the first region Al of the cylinder 11 and an air flow path 15b of the inclined member 15 passes, and a valve body portion 22 that slides along an extending direction D4 of the air hole 21h in a state where the valve body portion 22 is passed through the air hole 21h. The check valve 20 includes a check valve spring 23 that biases the valve body portion 22 to the side opposite to the tire 110 (in a diagonally down-left direction in FIG. 4), and a support portion 24 that supports an end portion on the tire 110 side of the check valve spring 23.

The valve seat portion 21 is made of, for example, aluminum. The valve seat portion 21 includes, for example, a first attachment portion 21b attached to the inclined member 15, and a second attachment portion 21c attached to the wheel 100. For example, the shape of the valve seat portion 21 is similar to the shape of the weight 12. The valve seat portion 21 includes a first air flow path 21d located inside the first attachment portion 21b, and a second air flow path 21f which communicates with the first air flow path 21d, and in which the valve body portion 22, the check valve spring 23, and the support portion 24 are accommodated.

The valve seat portion 21 is attached to the inclined member 15, for example, by screwing the first attachment portion 21b into the inclined member 15. For example, an O-ring 25 for ensuring airtightness is provided between the valve seat portion 21 and the inclined member 15. The second attachment portion 21c is provided with, for example, two nuts 21g and a seal member 21j. The second attachment portion 21c is attached to the wheel 100 using the two nuts 21g and the seal member 21j.

The valve body portion 22 includes a slide member 22b that slides in the extending direction D4 in a state where the slide member 22b is passed through the air hole 21h, and an airtight member 22c attached to the slide member 22b. At least one of the shape and the material of the slide member 22b is the same as at least one of the shape and the material of the slide member 31 described above.

For example, the material of the check valve spring 23 is the same as the material of the backflow prevention valve spring 32. A spring constant of the check valve spring 23 is larger than a spring constant of the backflow prevention valve spring 32. For example, a set load of the check valve spring 23 is larger than a set load of the backflow prevention valve spring 32. For example, a load (holding force) at which the check valve 20 starts to move is larger than a load at which the backflow prevention valve 30 starts to move. The support portion 24 has, for example, the same shape as the support portion 33 of the backflow prevention valve 30.

The support portion 24 is a bearing for the slide member 22b. A space on a side opposite to the check valve spring 23 when viewed from the support portion 24 communicates with the internal space of the tire 110. The slide member 22b and the airtight member 22c are movable in the extending direction D4 with respect to the support portion 24. When the slide member 22b and the airtight member 22c have moved to the side opposite to the tire 110, the air hole 21h of the valve seat portion 21 is closed. On the other hand, when the slide member 22b and the airtight member 22c have moved to the tire 110 side, the air hole 21h is opened.

Next, the inclined member 15 will be described. The inclined member 15 is a component that causes the extending direction D4 of the check valve 20 to be inclined with respect to the first direction D1 that is an extending direction of the cylinder 11. The inclined member 15 includes, for example, a first portion 15c to which the cylinder 11 is attached; a second portion 15d to which the check valve 20 is attached; and a fragile portion 15f located between the first portion 15c and the second portion 15d.

The first portion 15c and the second portion 15d have, for example, a tubular shape. An axial direction of the first portion 15c coincides with the first direction D1. An axial direction of the second portion 15d coincides with the extending direction D4. The inclined member 15 is a component that causes the extending direction of the check valve 20 to be inclined with respect to the cylinder 11. For example, a plurality of types of the inclined members 15 are prepared.

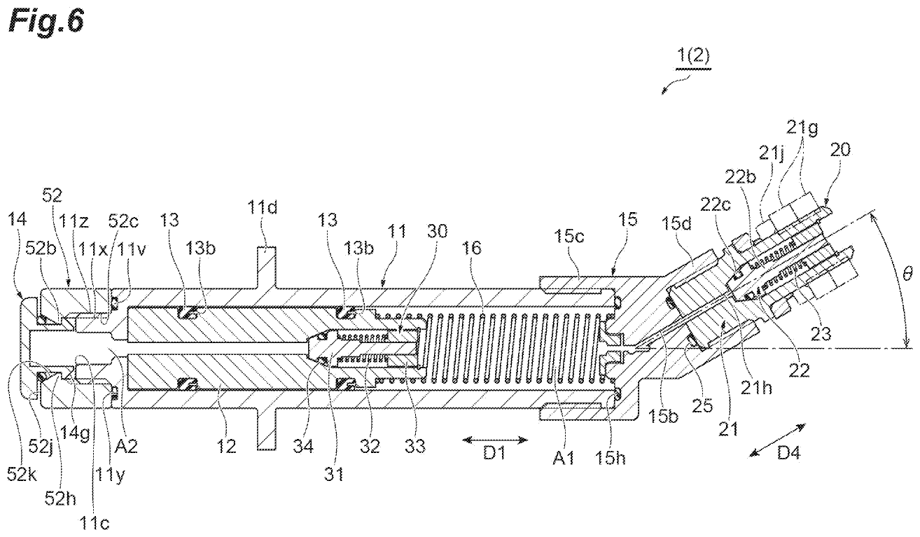

As shown in FIGS. 4 and 6, the plurality of types of inclined members 15 are different from each other in an inclination angle θ of the axial direction of the second portion 15d with respect to the axial direction of the first portion 15c. By preparing the plurality of types of inclined members 15 having different inclination angles θ in advance (for example, before the tire air filling device 1 is attached to the wheel 100), the tire air filling device 1 can be attached to various wheels 100 at appropriate angles. Therefore, this approach contributes to improving the versatility of the tire air filling device 1.

The inclined member 15 is a connecting member that connects the cylinder 11 and the check valve 20 to each other. For example, the cylinder 11 is screwed into the first portion 15c, and the check valve 20 is screwed into the second portion 15d. The air flow path 15b of the inclined member 15 communicates with the first region Al of the cylinder 11 and the air hole 21h of the check valve 20. An O-ring 15h for ensuring airtightness is disposed between the cylinder 11 and the inclined member 15.

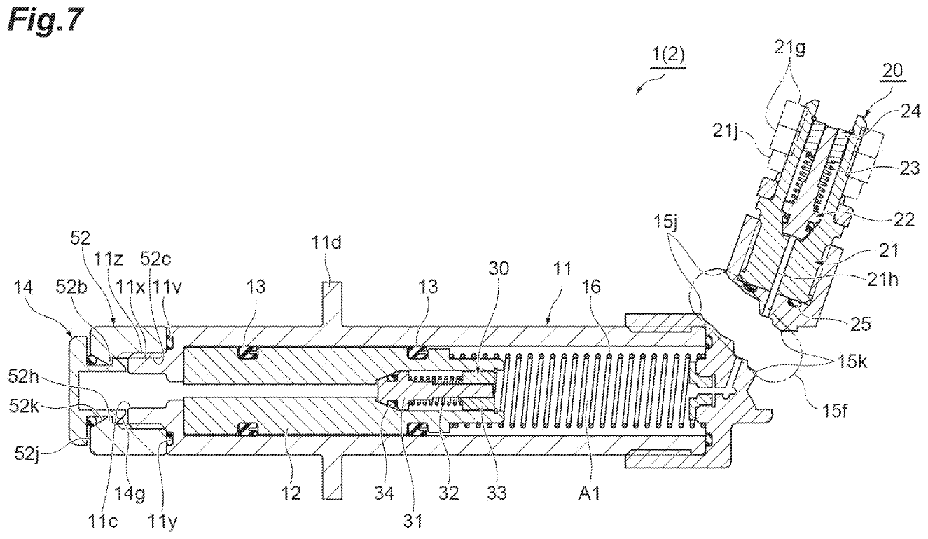

As shown in FIGS. 4 and 7, the fragile portion 15f is a portion that breaks when an external force is applied to the tire air filling device 1. The fragile portion 15f is provided, for example, between a first recess 15j that is a portion at which the fragile portion 15f is bent from the first portion 15c to the second portion 15d and a second recess 15k formed at an end portion on an opposite side of the first portion 15c from the cylinder 11.

By causing the fragile portion 15f of the inclined member 15 to preferentially break due to the application of an external force, damage to the check valve 20 due to the application of the external force can be avoided. Incidentally, instead of the fragile portion 15f of the inclined member 15, the cylinder 11 may include a fragile portion. In this case, since the cylinder 11 breaks preferentially as an external force is applied, similarly to the above-described configuration, damage to the check valve 20 can be avoided.

Next, an example of an operation of the tire air filling device 1 will be described with reference to FIG. 4. For example, in a state where the automobile to which the tire air filling device 1 is attached is stopped, the weight 12 is located on the side opposite to the tire 110 (the left side in FIG. 4) due to the biasing force of the weight spring 16.

At this time, the slide member 31 inside the weight 12 is located on the side opposite to the tire 110 due to the biasing force of the backflow prevention valve spring 32, and the backflow prevention valve airtight member 34 closes the air flow hole 12b. The valve body portion 22 of the check valve 20 is located on the side opposite to the tire 110 (diagonally downward left in FIG. 4) due to the biasing force of the check valve spring 23, and the valve body portion 22 closes the air hole 21h.

When the automobile accelerates, the weight 12 moves to the tire 110 side (right side in FIG. 4) against the biasing force of the weight spring 16 upon a receipt of a centrifugal force due to the rotation of the wheel 100. At this time, air enters the second region A2 of the cylinder 11 from the lid member 14 as the weight 12 moves to the tire 110 side. As the weight 12 moves toward the tire 110 side, the air pressure in the first region Al increases, air flows from the first region Al to the check valve 20 via the air flow path 15b of the inclined member 15, and the valve body portion 22 opens the air hole 21h. The air that has flowed to the check valve 20 is injected to the inside of the tire 110 due to opening of the air hole 21h.

For example, in a state where the automobile travels at a speed of 40 km/h, a state where the weight 12 is located on the tire 110 side and the weight spring 16 is compressed is maintained. When an air pressure of the tire 110 is lower than an air pressure of the first region A1, the valve body portion 22 opens the air hole 21h, and air is supplied from the first region Al to the inside of the tire 110 via the air hole 21h. On the other hand, when the air pressure of the tire 110 is more than or equal to the air pressure of the first region A1, the valve body portion 22 closes the air hole 21h, and air is not supplied to the tire 110.

When the automobile decelerates, the weight 12 is moved to the side opposite to the tire 110 by the biasing force of the weight spring 16. At this time, the slide member 31 inside the weight 12 moves toward the tire 110 side with respect to the weight 12 against the biasing force of the backflow prevention valve spring 32, and the backflow prevention valve airtight member 34 opens the air flow hole 12b. Air in the second region A2 of the cylinder 11 enters the first region Al via the air flow hole 12b due to opening of the air flow hole 12b. Then, when the automobile is stopped, the tire air filling device 1 returns to an initial state shown in FIG. 4.

Next, actions and effects obtained from the tire air filling device 1 according to the present embodiment will be described. In the tire air filling device 1, the cylinder 11 has the first opening 11r communicating with the inside of the tire 110. The weight 12 that supplies air to the inside of the tire 110 via the first opening 11r is provided inside the cylinder 11. The weight 12 is moved in the axial direction (first direction D1) of the cylinder 11 by a centrifugal force, thereby being able to fill the tire 110 with air during traveling.

The tire air filling device 1 has the second opening 11c facing a side opposite to the first opening 11r. The cap 52 is detachably attached to the second opening 11c. During stop of traveling, by opening the second opening 11c through opening the cap 52, air can be forcibly supplied from the second opening 11c to the tire 110. During traveling, the cap 52 is closed, so that the weight 12 can fill the tire 110 with air using a centrifugal force, and during stop of traveling, the cap 52 is removed, so that air can be directly supplied from the second opening 11c to the tire 110.

In the present embodiment, the tire air filling device 1 includes the plurality of weight airtight members 13. The plurality of weight airtight members 13 are aligned along the axial direction of the cylinder 11. A cross section of each of the plurality of weight airtight members 13 taken along a plane extending along the axial direction has a U-shape with the open end 13b. The plurality of weight airtight members 13 are disposed such that the open ends 13b face the first opening 11r side. By the way, when an O-ring is used as the airtight member, high dimensional accuracy is required depending on the inner diameter of the cylinder 11, the outer diameter of the weight 12, or the like. On the other hand, when the weight airtight member 13 having a U-shaped cross section when taken along a plane extending along the axial direction is used, the dimensional accuracy can be relaxed.

The U-shaped open ends 13b of the plurality of weight airtight members 13 face the first opening 11r side. Therefore, sliding resistance when the weight 12 moves to the first opening 11r side can be increased compared to when the weight 12 moves to a side opposite to the first opening 11r. Therefore, sliding resistance when the weight 12 returns due to the biasing force of the weight spring 16 is reduced, so that the air pushed into the tire 110 can be made to be less likely to leak.

In the present embodiment, the tire air filling device 1 includes the backflow prevention valve 30 that is provided inside the weight 12, and that prevents a backflow of air from the weight 12 to the side opposite to the tire 110. The backflow prevention valve 30 includes the slide member 31 that slides in the axial direction in the air flow hole 12b. The specific gravity of the slide member 31 is smaller than the specific gravity of the weight 12. Therefore, the centrifugal force increases to move the weight 12 to the first opening 11r side (tire 110 side). When the air pressure on the first opening 11r side of the cylinder 11 increases, the movement of the slide member 31 can be suppressed to prevent the backflow prevention valve 30 from opening unintentionally. Therefore, air can be more efficiently sent to the tire 110 side due to the weight 12.

In the present embodiment, the tire air filling device 1 includes the inclined member 15 that is attached to the check valve 20 and the cylinder 11 in a state where the check valve 20 is inclined with respect to the cylinder 11. By interposing the inclined member 15 between the check valve 20 and the cylinder 11, the direction of the check valve 20 with respect to the cylinder 11 can be changed.

As shown in FIGS. 4 and 6, the inclined member 15 having the inclination angle θ matching the shape of the wheel 100 can be attached between the cylinder 11 and the check valve 20. By preparing the plurality of types of inclined members 15 in advance, selecting the inclined member 15 matching the shape of the wheel 100, and attaching the inclined member 15, the tire air filling device 1 can be appropriately attached to various wheels 100. The versatility of the tire air filling device 1 can be increased.

In the present embodiment, at least one of the inclined member 15 and the cylinder 11 includes a fragile portion (for example, the fragile portion 15f) that is more fragile than the check valve 20 and that breaks due to an external force. For example, when the wheel 100 collides with a curb or the like during traveling and the check valve 20 attached to the wheel 100 is damaged, air in the tire 110 leaks and the automobile is unable to travel, which is a risk. On the other hand, in a case where the inclined member 15 interposed between the check valve 20 and the cylinder 11 or the cylinder 11 includes a fragile portion as described above, even when the wheel 100 receives an impact force, the fragile portion breaks. Therefore, damage to the check valve 20 can be suppressed by breakage of the fragile portion provided in at least one of the inclined member 15 and the cylinder 11. Therefore, the leakage of air from the tire 110 due to an impact force on the wheel 100 can be more reliably suppressed.

In the present embodiment, the backflow prevention valve 30 includes the slide member 31 that slides in the axial direction in the air flow hole 12b, and the backflow prevention valve spring 32 that biases the slide member 31. The check valve 20 includes the valve seat portion 21 having the air hole 21h; the valve body portion 22 that slides in the air hole 21h; and the check valve spring 23 that biases the valve body portion 22 to the side opposite to the tire 110. The spring constant of the check valve spring 23 is larger than the spring constant of the backflow prevention valve spring 32. Since the spring constant of the check valve spring 23 is larger than the spring constant of the backflow prevention valve spring 32, the leakage of air from the tire 110 at the check valve 20 can be more reliably suppressed.

In the present embodiment, the set load of the check valve spring 23 is larger than the set load of the backflow prevention valve spring 32. Since the set load of the check valve spring 23 is larger than the set load of the backflow prevention valve spring 32, the leakage of air from the tire 110 at the check valve 20 can be more reliably suppressed.

In the present embodiment, the weight 12 includes the accommodation portion 12h that accommodates the backflow prevention valve 30, and at least a part of the accommodation portion 12h is inserted into the weight spring 16. Therefore, at least a part of the accommodation portion 12h of the backflow prevention valve 30 is inserted into the weight spring 16. Since the accommodation portion 12h of the weight 12 is inserted into the weight spring 16, a change in the internal space of the cylinder 11 due to the movement of the weight 12 can be increased. Since the pressure generated inside the cylinder 11 can be increased without increasing the size of the cylinder 11, the supply of air to the tire 110 can be efficiently performed, and a contribution to making the components more compact is made.

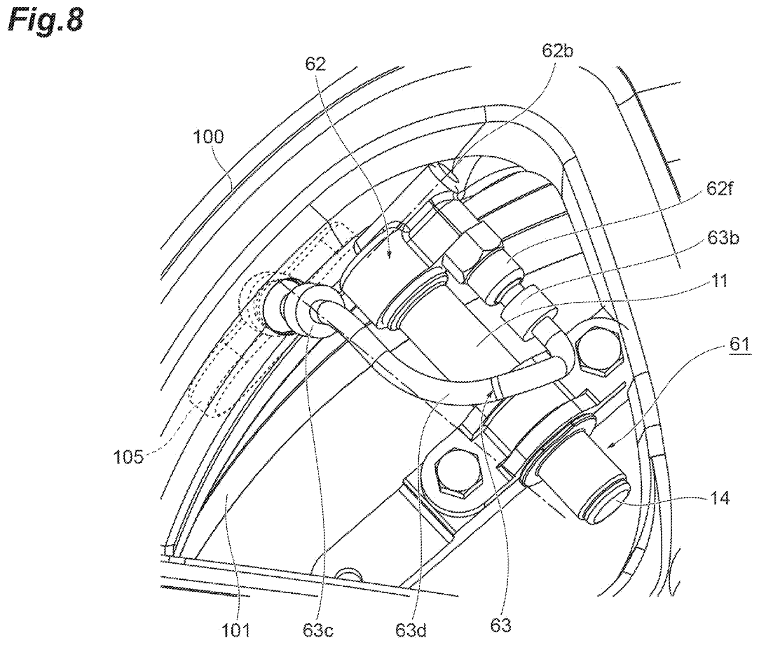

In the embodiment described above, the tire air filling device 1 including the check valve 20 has been described. However, the tire air filling device may not include a check valve. For example, the tire air filling device may be mounted on a check valve attached to the wheel 100 of the tire 110 in advance. Hereinafter, the example will be described with reference to FIGS. 8, 9, and 10.

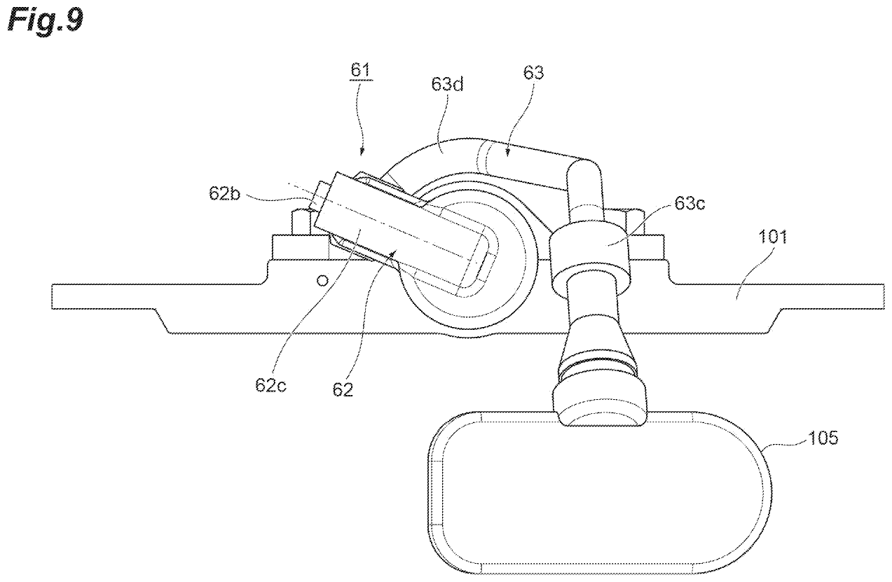

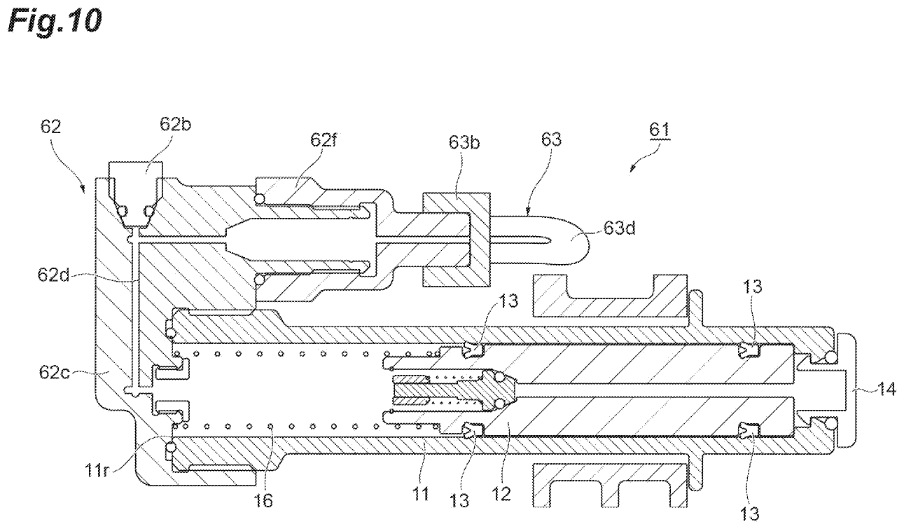

FIG. 8 is a perspective view showing a tire air filling device 61 attached to the wheel 100. FIG. 9 is a view showing the tire air filling device 61 when viewed in a direction different from that in FIG. 8. FIG. 10 is a cross-sectional view of the tire air filling device 61. In FIGS. 8 to 10, some illustrations are simplified for ease of understanding. As shown in FIGS. 8 to 10, the tire air filling device 61 includes the cylinder 11 having the first opening 11r communicating with the tire 110, and the weight 12 that is provided inside the cylinder 11, and that moves in the axial direction of the cylinder 11 upon a receipt of a centrifugal force, to supply air to the tire 110. Further, the tire air filling device 61 includes the weight airtight members 13 interposed between the weight 12 and the inner surface of the cylinder 11, and the weight spring 16.

The wheel 100 includes a tire pressure monitoring system (TPMS) unit 105. The TPMS unit 105 includes, for example, a pressure sensor that monitors the air pressure of the tire 110, and a check valve. For example, the tire air filling device 61 is connected to the TPMS unit 105 via a tube 63. The tube 63 includes a first connection portion 63b that is a portion connected to the tire air filling device 61; a second connection portion 63c that is a portion connected to the TPMS unit 105; and a tube body 63d extending from the first connection portion 63b to the second connection portion 63c. For example, the tube body 63d is made of a flexible material. In this case, the tube body 63d can be flexibly deformed.

The tire air filling device 61 includes a cap assembly 62 attached to the first opening 11r of the cylinder 11. The cylinder 11 is connected to the tube 63 via the cap assembly 62. The cap assembly 62 includes an air flow path 62d communicating with an internal space of the tube 63 and an internal space of the TPMS unit 105. Air from the cylinder 11 is supplied to the tire 110 via the air flow path 62d, the internal space of the tube 63, and the internal space of the TPMS unit 105.

The cap assembly 62 includes, for example, a first cap portion 62c mounted on the cylinder 11, and a second cap portion 62f mounted on the first cap portion 62c. The air flow path 62d includes an internal space of the first cap portion 62c and an internal space of the second cap portion 62f. The internal space of the cylinder 11 communicates with the internal space of the tube 63 via the internal space of the first cap portion 62c and the internal space of the second cap portion 62f. The second cap portion 62f is provided, for example, at a position adjacent to the cylinder 11. For example, in the tire air filling device 61, the cylinder 11 and the second cap portion 62f extend from the first cap portion 62c in the same direction (rightward in FIG. 10). Accordingly, the tire air filling device 61 can be made compact.

The internal space of the first cap portion 62c extends from the cylinder 11 in a direction intersecting the internal space of the cylinder 11 (upward in FIG. 10), and then is bent in the same direction as the internal space of the cylinder 11 (rightward in FIG. 10). For example, the cap assembly 62 includes a small cap 62b that is detachably attached to the first cap portion 62c. The small cap 62b opens the air flow path 62d by being removed from the first cap portion 62c. In a state where the small cap 62b is removed and the air flow path 62d is opened, for example, air can be supplied from the portion, from which the small cap 62b is removed, to the tire 110 at a gas station.

As described above, the tire air filling device 61 according to the modification example does not include a check valve. The tire air filling device 61 is provided with the weight 12 that supplies air to the inside of the tire 110 via the cap assembly 62, the tube 63, and the TPMS unit 105. The weight 12 is moved in the axial direction of the cylinder 11 by a centrifugal force, thereby being able to fill the tire 110 with air. Therefore, the same actions and effects as those of the tire air filling device 1 and the like described above are obtained from the tire air filling device 61.

The embodiment and the modification examples of the tire air filling device according to the present disclosure have been described above. However, the tire air filling device according to the present disclosure is not limited to the embodiment or the modification examples described above, and may be modified or applied to other uses without changing the concept described in the claims. Namely, the shapes, sizes, numbers, materials, and disposition mode of the parts of the tire air filling device are not limited to each example described above, and can be changed as appropriate.

For example, an example in which the weight 12 is made of tungsten or a tungsten alloy has been described above. However, the material of the weight may contain, for example, gold, and is not limited to tungsten or to a tungsten alloy, and can be changed as appropriate. The same applies to the materials of parts other than the weight, such as the slide member.

### REFERENCE SIGNS LIST

1: tire air filling device, 2: device body, 3: attachment member, 4: clamp, 4b: first clamp portion, 4c: second clamp portion, 4d: end portion, 4f: central portion, 4g: insertion hole, 4h: protruding portion, 4j: recess, 4k: screw hole, 4p: end portion, 4q: central portion, 4r: insertion hole, 5: bolt, 11: cylinder, 11b: inner surface, 11c: second opening, 11d: flange portion, 11r: first opening, 11v: O-ring, 11x: tubular portion, 11y: recess, 11z: male screw, 12: weight, 12b: air flow hole, 12c: first space portion, 12d: second space portion, 12f: outer peripheral surface, 12g: annular recess, 12h: accommodation portion, 12j: large-diameter portion, 12m: annular recess, 12p: annular protrusion, 12r: tapered surface, 12s: inner peripheral surface, 13: weight airtight member, 13b: open end, 14: lid member, 14b: sealing portion, 14c: protruding portion, 14d: engagement portion, 14g: tapered surface, 15: inclined member, 15b: air flow path, 15c: first portion, 15d: second portion, 15f: fragile portion, 15h: O-ring, 15j: first recess, 15k: second recess, 16: weight spring, 20: check valve, 21: valve seat portion, 21b: first attachment portion, 21c: second attachment portion, 21d: first air flow path, 21f: second air flow path, 21g: nut, 21h: air hole, 22: valve body portion, 22b: slide member, 22c: airtight member, 23: check valve spring, 24: support portion, 25: O-ring, 30: backflow prevention valve, 31: slide member, 31b: end surface, 31c: inclined surface, 31d: shaft portion, 31f: annular recess, 32: backflow prevention valve spring, 33: support portion, 34: backflow prevention valve airtight member, 52: cap, 52b: engagement portion, 52c: screw portion, 52h: protrusion, 52j: end surface, 52k: tapered surface, 61: tire air filling device, 62: cap assembly, 62b: small cap, 62c: first cap portion, 62d: air flow path, 62f: second cap portion, 63: tube, 63b: first connection portion, 63c: second connection portion, 63d: tube body, 100: wheel, 101: spoke, 102: central portion, 103: rim, 110: tire, A1: first region, A2: second region, D1: first direction, D2: second direction, D3: third direction, D4: extending direction, S: gap, W1: width, θ: inclination angle.

1. A tire air filling device that is provided on a wheel attached to a tire, and that compresses air and fills an inside of the tire with the air, the device comprising:
a cylinder having a first opening communicating with the tire;
a weight that is provided inside the cylinder, that has an air flow hole through which the air to be supplied to the tire passes, and that moves in an axial direction of the cylinder upon a receipt of a centrifugal force, to supply the air from the first opening to the tire;
a weight airtight member interposed between the weight and an inner surface of the cylinder; and
a weight spring that biases the weight to a side opposite to the tire,
wherein the cylinder has a second opening on a side opposite to the first opening, and
a cap that is detachably attached to the second opening is provided.

2. The tire air filling device according to claim 1, further comprising:
a plurality of the weight airtight members,
wherein the plurality of weight airtight members are aligned along the axial direction,
a cross section of each of the plurality of weight airtight members taken along a plane extending along the axial direction has a U-shape with an open end, and
the plurality of weight airtight members are disposed such that the open ends face a first opening side.

3. The tire air filling device according to claim 1, further comprising:
a backflow prevention valve provided inside the weight, and preventing a backflow of the air from the weight to the side opposite to the tire,
wherein the backflow prevention valve includes a slide member that slides in the axial direction in the air flow hole, and
a specific gravity of the slide member is smaller than a specific gravity of the weight.

4. The tire air filling device according to claim 1, further comprising:
an inclined member attached to a check valve that prevents a backflow of the air from the tire to the inside of the cylinder, and to the cylinder in a state where the cylinder is inclined with respect to the check valve.

5. The tire air filling device according to claim 4,
wherein at least one of the inclined member and the cylinder includes a fragile portion that is more fragile than the check valve and that breaks due to an external force.

6. The tire air filling device according to claim 4, further comprising:
a backflow prevention valve provided inside the weight, and preventing a backflow of the air from the weight to the side opposite to the tire,
wherein the backflow prevention valve includes a slide member that slides in the axial direction in the air flow hole, and a backflow prevention valve spring that biases the slide member to the side opposite to the tire,
the check valve includes a valve seat portion having an air hole, a valve body portion that slides in the air hole, and a check valve spring that biases the valve body portion to the side opposite to the tire, and
a spring constant of the check valve spring is larger than a spring constant of the backflow prevention valve spring.

7. The tire air filling device according to claim 4, further comprising:
a backflow prevention valve provided inside the weight, and preventing a backflow of the air from the weight to the side opposite to the tire,
wherein the backflow prevention valve includes a slide member that slides in the axial direction in the air flow hole, and a backflow prevention valve spring that biases the slide member to the side opposite to the tire,
the check valve includes a valve seat portion having an air hole, a valve body portion that slides in the air hole, and a check valve spring that biases the valve body portion to the side opposite to the tire, and
a set load of the check valve spring is larger than a set load of the backflow prevention valve spring.

8. The tire air filling device according to claim 1, further comprising:
a backflow prevention valve provided inside the weight, and preventing a backflow of the air from the weight to the side opposite to the tire,
wherein the weight includes an accommodation portion that accommodates the backflow prevention valve, and
at least a part of the accommodation portion is inserted into the weight spring.
